(19) United States
(12) Patent Application Publication
(10) Pub. No.: US 2014/0100118 A1
(43) Pub. Date: Apr. 10, 2014

(54) METHOD FOR CONTINUOUSLY FORMING SUPERCONDUCTING WIRE AND PRODUCTS THEREFROM

(71) Applicant: HYPER TECH RESEARCH, INC., COLUMBUS, OH (US)

(72) Inventors: David D. Doll, Westerville, OH (US); Michael J. Tomsic, Troy, OH (US); Matthew Rindfleisch, Powell, OH (US); Chee June Thong, Dublin, OH (US); Hoong Pak Jinji Yue, Dublin, OH (US); Trent Wieber, Pickerington, OH (US); Justin Wells, Hilliard, OH (US)

(73) Assignee: HYPER TECH RESEARCH, INC., COLUMBUS, OH (US)

(21) Appl. No.: 14/044,443

(22) Filed: Oct. 2, 2013

Related U.S. Application Data
(60) Provisional application No. 61/710,126, filed on Oct. 5, 2012.

(51) Int. Cl. H01B 12/02

(52) U.S. Cl. CPC H01B 12/02
USPC 505/231; 505/433; 505/230; 29/599; 174/125.1

(57) ABSTRACT

A device and method for continuously forming superconducting wire, and products made therefrom. The method may include providing at least one continuous metal sheathing strip and at least one metal form, continuously forming the at least one continuous metal sheathing strip to form a partially open configuration, continuously filling the partially open configuration with magnesium diboride precursor comprising boron, and a metal form, and closing the partially open configuration thereby enclosing the magnesium diboride precursor comprising boron, and a metal form, to form a closed configuration. Subsequent reduction in diameter and elongation in length of the closed configuration, followed by heat treatment, catalyzes the transformation of the magnesium diboride precursor comprising boron, and the metal form, to magnesium diboride to form the superconducting wire.

### CROSS-REFERENCE TO RELATED APPLICATIONS

This application claims priority to U.S. Provisional Patent Application Ser. No. 61/710,126; filed Oct. 5, 2012; which is incorporated by reference as if completely written herein.

### STATEMENT REGARDING FEDERALLY SPONSORED RESEARCH OR DEVELOPMENT

This invention was made with government support under grant 1RC3EB011906-01 awarded by the Department of Health and Human Services. The government has certain rights in the invention.

### BACKGROUND OF THE INVENTION

Superconductivity is a property of many metals, alloys and chemical compounds in which the electrical resistivity of the materials vanishes and the materials become strongly diamagnetic at temperatures near absolute zero.

In order for a material to exhibit superconducting behavior, the material must be cooled below a characteristic temperature, known as its superconducting transition or critical temperature (T_{c}). The T_{c} of superconducting materials based on intermetallic compounds has traditionally been under 20 K. These intermetallic superconductors have been typically operated in a bath of liquid helium at a temperature of about 4.2 K. It has, however, been recently reported that an intermetallic compound, specifically magnesium diboride (MgB₂), can have superconducting properties at about 39 K. Thus, it would be possible to utilize magnesium diboride as a superconductor by cooling with a conventional closed-cycle refrigerator, which is capable of cooling objects to 10-30 K with no liquid cryogens.

Wires made with superconducting materials provide significant advantages over conventional copper wires because they conduct electricity with little or no resistance and associated energy loss, and they can transmit much larger amounts of electricity than conventional wires of the same size.

Superconducting wires have enabled high current density in a conductor, which has enabled high field magnets. This in turn has enabled magnetic resonance imaging (MRI) of increased resolution and clarity, a goal for all medical diagnosis. Traditionally, the wire of choice has been niobium titanium (NbTi) for achieving high magnetic fields in high energy physics applications. The emergence of MRI has since dominated the market for this product for a number of reasons. First, NbTi is ductile and can undergo considerable strain (˜1%) before failing, thereby greatly simplifying manufacturing. Second, successive lengths can be easily joined by compressing the bare exposed NbTi filaments together and securing them in a pot of solder, and in particular, in a pot of low temperature solder. Despite all the benefits offered by NbTi wire, it has a single weakness that greatly affects its desirability as an MRI superconductor, namely it quenches (undergoes transition into normal electrical conducting mode) easily. Micro-joules of energy can drive local temperatures from its stable operating temperature of 4.2 K (liquid helium at atmospheric pressure) to its operating limit of ˜5.5 K, depending on current density and background field.

Magnesium diboride (MgB₂) was shown to be superconducting in 2001 and was made into filamented wire form shortly thereafter. With its critical temperature of 39 K, it is highly temperature tolerant and not sensitive to local low energy inputs such as cracks in epoxy potting material. However, joining the ends of successive wire lengths presents several issues. MgB₂ has a low strain tolerance: 0.4% maximum and a working strain limit of 0.2%. This is not as sensitive as certain competitor high temperature superconducting (HTS) materials such as bismuth strontium calcium copper oxide (BSCCO) and yttrium barium copper oxide (YBCO), but it requires special consideration when attempting to place MgB₂, particularly reacted MgB₂, into direct contact with MgB₂, a necessary condition for joint persistence and applicability to MRI magnets. The limiting factor is inextricably tied to the required construction of MgB₂ wire.

MgB₂ wire has only a few constituent materials, generally four in number, each providing an essential function. The MgB₂ itself is frequently contained in a sheath of niobium (Nb) or iron (Fe). However, titanium (Ti), tantalum (Ta), and nickel (Ni) can also be used to prevent the degrading effect of any surrounding copper (Cu) or copper alloy contamination during heat treatment, which can take place in a range of between approximately 1 and 1200 minutes in duration, and a temperature of approximately 550° to 900° C. In a preferred embodiment, such heat treatment may take place in approximately 20 minutes at approximately 650° C., depending on the reaction time of the magnesium and the boron. The Cu provides the essential stability for MgB₂ wire while the MgB₂ is carrying current in the superconducting mode. At the moment of incipient quench, the current leaves the MgB₂ and enters the Cu or Cu alloy. Under certain transient conditions, the Cu carries the current temporarily and heats ohmically, and upon subsequent cooling, allows the current to re-enter the MgB₂. Around the outside of the wire is a strong, ductile material used to facilitate drawing to the required size and shape. Although there are other candidate materials, to date, the material of choice continues to be Ni—Cu alloys, such as in some embodiments, Monel® 400 (MONEL is a trademark of Special Metals Corporation, New Hartford, N.Y., U.S.A.). It provides the ductility necessary to draw the Cu, and Nb or Fe without failure while providing electrical and thermal properties suitable for stability when wound into a magnet.

Over the years since MgB₂ discovery in 2001 as a superconductor, there have been four main routes for the processing of MgB₂ wires: 1) ex-situ-made MgB₂ powder, put into wire, drawn, and sintered, ending up with 70% dense MgB₂, 2) in-situ mixed powders of Mg+2B, put into wire, drawn, and heat treated at the end of the process, ending up with approximately 50% dense MgB₂, 3) a version of in-situ plus cold pressing wire before heat treating, ending up with about 55% dense MgB₂ after heat treatment, and 4) a magnesium diffusion route (IMD) using solid magnesium plus boron powder, with the magnesium diffusing into the boron during heat treatment, yielding a 90-100% dense MgB₂ layer, leaving behind a void where the magnesium was previously.

In this specification, the term “superconducting precursor,” “magnesium diboride precursor” and/or “precursor” shall mean those elements, compounds or mixtures containing Mg and/or Mg alloy, or B and/or B alloy, or both which upon suitable reaction processes, have the capacity to form electrically superconducting compounds. The term “metal form” shall mean a magnesium diboride precursor that includes, but is not limited to, magnesium. Superconducting precursors, magnesium diboride precursors and/or precursors may also contain variable amounts of already formed MgB₂. The Mg diffuses into the B to form MgB₂, and voids (porosity) are present where the Mg was previously located. In a macro sense, the original volume occupied by the densely packed precursors decreases by approximately 22% with the depletion of Mg to form MgB₂.

### SUMMARY OF THE INVENTION

Numerous variations, modifications, alternatives, and alterations of the various preferred embodiments, processes, and methods may be used alone or in combination with one another as will become more readily apparent to those with skill in the art, with reference to the following detailed description of the preferred embodiments and the accompanying figures and drawings.

In its most general configuration, the present invention advances the state of the art with a variety of new capabilities and overcomes many of the shortcomings of prior devices in new and novel ways. In its most general sense, the present invention overcomes the shortcomings and limitations of the prior art in any of a number of generally effective configurations. The instant invention demonstrates such capabilities and overcomes many of the shortcomings of prior methods in new and novel ways.

Advantages of the method of the specification include, but are not limited to, the continuous manufacturing of second generation MgB₂-based superconducting wires, leading to better performing wires than first generation wires that are also low cost, and of long wire piece length. Such second generation MgB₂ wire is also cost-disruptive compared to other superconductors, especially YBCO coated conductor, and enables conduction cooled 1.5 T and 3.0 T MRI's. Enhanced flexibility in manufacturing of wire of various architectures and designs is also provided.

### BRIEF DESCRIPTION OF THE DRAWINGS

Without limiting the scope of the Method for Continuously Forming Superconducting Wire and Products Therefrom as claimed below and referring now to the drawings and figures, all shown not-to-scale:

FIG. 1 shows a schematic plan view of an embodiment of the continuous process apparatus of an embodiment of the present invention;

FIG. 2 shows a cross-sectional view taken along line 2-2 of FIG. 1;

FIG. 3 shows a cross-sectional view taken along line 3-3 of FIG. 1;

FIG. 4 shows schematic plan view of the continuous process apparatus of another embodiment of the present invention;

FIG. 5 shows a cross-sectional view taken along line 5-5 of FIG. 4;

FIG. 6 shows a cross-sectional view taken along line 6-6 of FIG. 4;

FIG. 7 shows schematic plan view of the continuous process apparatus of another embodiment of the present invention;

FIG. 8 shows a cross-sectional view taken along line 8-8 of FIG. 7;

FIG. 9 shows a cross-sectional view taken along line 9-9 of FIG. 7;

FIG. 10 shows a cross-sectional view of an embodiment of a superconducting wire made by an embodiment of the invention;

FIG. 11 shows a cross-sectional view of another embodiment of a superconducting wire made by an embodiment of the invention;

FIG. 12 shows a cross-sectional view of another embodiment of a superconducting wire made by an embodiment of the invention;

FIG. 13 shows a cross-sectional view of another embodiment of a superconducting wire made by an embodiment of the invention;

FIG. 14 shows a cross-sectional view of another embodiment of a superconducting wire made by an embodiment of the invention, and

FIG. 15 shows a cross-sectional view of another embodiment of a superconducting wire made by an embodiment of the invention.

These drawings are provided to assist in the understanding of the exemplary embodiments of the device as described in more detail below and should not be construed as unduly limiting the device. In particular, the relative spacing, positioning, sizing and dimensions of the various elements illustrated in the drawings are not drawn to scale and may have been exaggerated, reduced or otherwise modified for the purpose of improved clarity. Those of ordinary skill in the art will also appreciate that a range of alternative configurations have been omitted simply to improve the clarity and reduce the number of drawings.

### DETAILED DESCRIPTION OF THE INVENTION

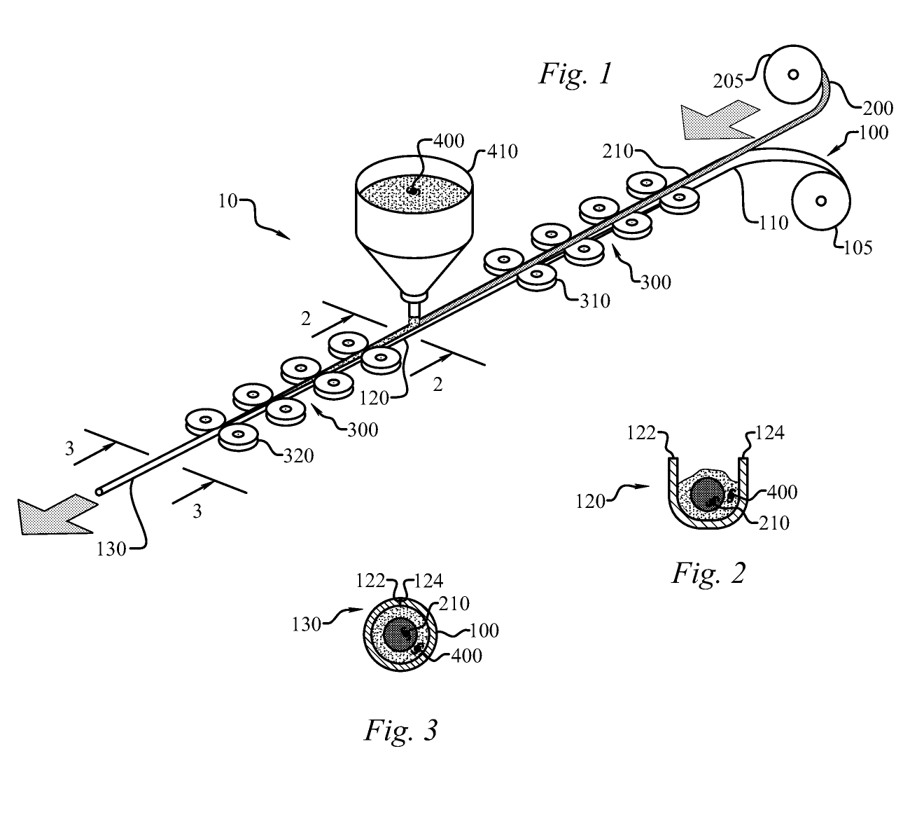

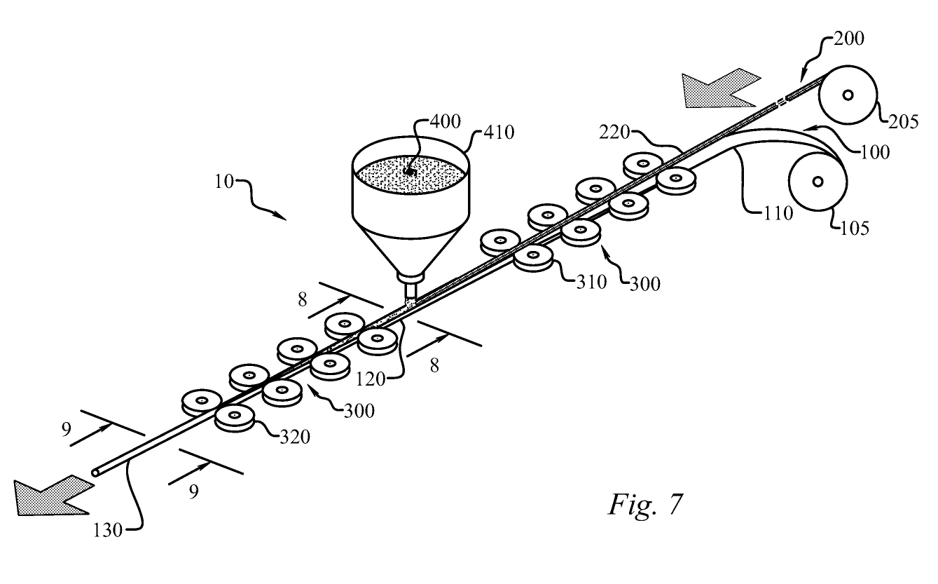

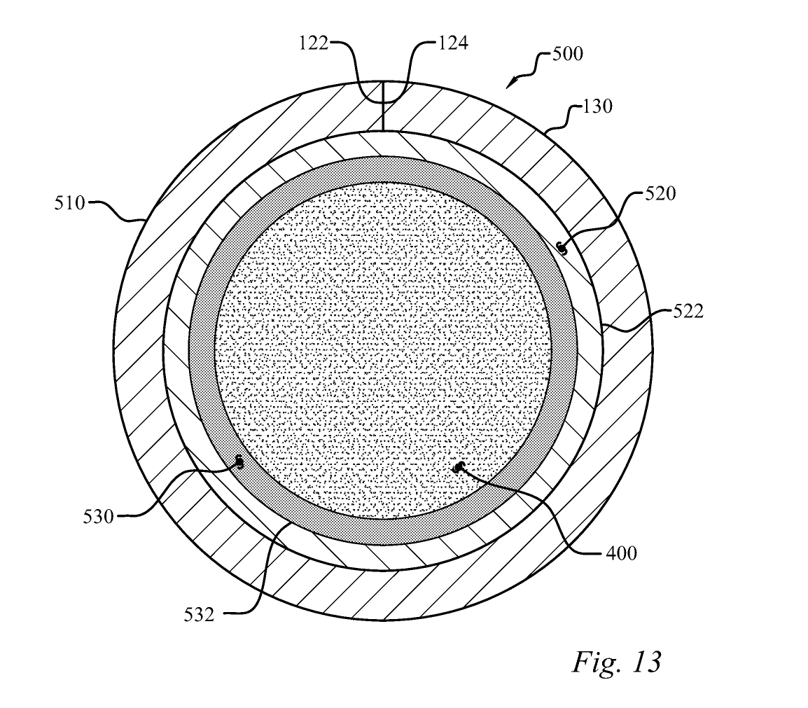

The method for continuously forming superconducting wire as depicted in some embodiments, by way of illustration and not limitation in FIGS. 1-15, discloses certain embodiments, by way of example only, of multi-form embodiments of a continuous tube forming and feeding apparatus for providing a superconducting wire with magnesium diboride precursor materials, and products made therefrom. There are at least two wire forms: monofilament and multifilament.

For monofilament wire formation, there are at least two embodiments: (1) the precursor materials which in one embodiment may be a metal form such as a magnesium wire, and powders where the powder may be boron powder or a mixture of magnesium and boron powders, (2) an embodiment where the precursor materials may be a metal form such as a magnesium strip, and powders that may be boron powder or mixture of magnesium and boron powders.

In a first embodiment, a metal sheathing strip can comprise any of a wide variety of metals, including silver, gold, platinum, palladium, rhodium, iridium, ruthenium, osmium, copper, aluminum, iron, nickel, chromium, titanium, molybdenum, tungsten, tantalum, niobium, magnesium, or vanadium, stainless steel, alloys and intermetallic mixtures thereof. Selection of the metal for the metal sheathing strip will be determined, by one skilled in the art, with reference to reactivity properties of metal with superconducting materials. In one preferred embodiment, the metal sheathing strip may comprise niobium, titanium, iron or stainless steel metal. The thickness of the metal sheathing strip is not critical and can be adjusted to the minimum thickness necessary, as would be determined by one skilled in the art, for processing to small diameter wire. In one embodiment, the diameter of the metal form, which may be a magnesium wire, is such that the ratio of the area enclosed by the closed metal sheathing strip A, to that of the metal form, which may be a magnesium wire, A_{Mg}, satisfies the ratios: 2.4<A/A_{Mg}<8.4.

In another embodiment, strip feeding mode, a metal sheathing strip lies external to a metal form, which may be a magnesium strip. The metal sheathing strip may comprise any one of a wide variety of metals, including silver, gold, platinum, palladium, rhodium, iridium, ruthenium, osmium, copper, aluminum, iron, nickel, chromium, titanium, molybdenum, tungsten, tantalum, niobium, magnesium, or vanadium, stainless steel, alloys and intermetallic mixtures thereof. Selection of the metal of the strip will be determined, by one skilled in the art, with reference to reactivity properties of metal with superconducting materials. In one preferred embodiment, the metal sheathing strip may comprise niobium, titanium, iron or stainless steel metals. The thickness of the metal sheathing strip is not critical and can be adjusted to the minimum thickness necessary, as would be known by one skilled in the art, for processing to small diameter wire. The width and thickness of metal form, which may be a magnesium strip, is such that the ratio of the area enclosed by the closed metal sheathing strip A, to that of the metal form, which may be a magnesium strip, A_{Mg}, satisfies the ratios: 2.4<A/A_{Mg}<8.4.

In some embodiments, it may be desirable, due to subsequent processing conditions in forming the superconducting wire, e.g., heat treatment or drawing, that the final metal tube formed includes multiple tubes so that there are inner tube(s) and outer tube(s). Where the inner tube can act as a barrier to prevent unwanted chemical reaction between the powder fill and the outer tube, the metal of the tube may be selected from a group of metals including nickel, titanium, molybdenum, tantalum, iron, niobium, tungsten, magnesium, vanadium, their alloys and intermetallic mixtures, and the like. In some embodiments, preferred materials for an inner tube include iron, titanium, niobium and tantalum. Whether or not an inner barrier tube is used, an outer tube can also be utilized as a stabilizer to aid in distribution of currents during a quench.

In such cases, the outer tube may be formed from a metal selected from the group including gold, silver, platinum, palladium, rhodium, copper and aluminum, with copper and aluminum being among preferred embodiments. In some embodiments, another outer tube can be formed from a sacrificial material selected from the group of metals including carbon steel, copper, stainless steel, copper-nickel, Monel, or nickel alloy. Such a sacrificial material can aid in reducing the cross section of the wire, and in the final or intermediate stages of area reduction, can be removed by etching off the sacrificial material.

Additionally, one of the tubes may be selected so as to provide mechanical strength to the final wire or tape, and in such case the tube material may be selected from the group including carbon, steel, stainless steel, copper, copper-nickel, Monel, or nickel alloy, and the like, with copper-nickel being among the preferred embodiments. Any of these formed tubes may be overlapped or welded. The powder contents of the configuration may include MgB₂, magnesium, boron, and/or intermetallic compounds formed by a combination of Group IIA and Group IIIA elements of the Periodic Table, including magnesium, aluminum, titanium, and the like, and ternary, quaternary or higher order compounds based thereon. In some embodiments, the powder may comprise Group II-III compounds, their constituent elements, or various combinations of compounds and elements. In one preferred embodiment, a superconductive precursor may be boron powder. The powder may be formed by one or more operations, including RF plasma treatment, compaction, sintering, melting, mechanical alloying, grinding, spray drying, and the like, with melting and mechanical alloying being among preferred embodiments. In some embodiments, the powder may be fine, and will generally be about 600 mesh (U.S. standard). In some embodiments, the powder may also contain various additives to improve the superconducting properties of the wire, e.g., increasing the critical fields, B_{c2}, and/or the transport current density, J_{c}. Such additives may include carbon, organics, titanium, silver, magnesium oxide, aluminum oxide, rare earth oxide, and the like, as would be known by one skilled in the art.

In some embodiments, the powder-filled, U-shaped configuration then proceeds through various closing dies to form an O-shaped closed tube. The closed tube may be formed such that ends of the U-shaped configuration are placed in proximity or overlapped and are then mechanically or metallurgically bonded as the powder-filled tube continues through any of a number of means for reducing the dimensional area of the tube. Means for area reduction are known to those skilled in the art and include wire drawing or forging by means of dies, roller dies, swagers or extruders, and the like. Whichever means are selected for area reduction, the cross section of the metal tube may generally be an annulus having a reduced dimensional area, in some embodiments, that is reduced in an amount from about 15% to about 99.99%, depending on the final use of the finished wire and current-carrying requirements. In some embodiments, it is preferable that the reduction in dimensional area be from about 90% to about 99.99%. Following area reduction, the closed metal tube will proceed to heat treatment to sinter or chemically react the contents of the tube. Heat treatment of the tube may occur continuously, such as with an inline furnace or resistive heating apparatus, or in a batch type oven. The heat treatment can involve a simple heating of the metal tube to a specific temperature for a specified time, or may be such that the tube is subjected to cycle of heating and cooling to various temperatures and for varying times. In some embodiments, heat treatment will generally be carried out at a temperature of from about 525° C. to about 1000° C., for a time of about one minute to about 6 hours. The metal tube (wire) may then be assembled into a coil or similar article. It is to be understood, however, that heat treatment may be performed either before or after winding of the finished tube (wire) into a coil form.

For multifilament wire, the metal form materials may be a group of wires. In some embodiments, the group may be all monofilament MgB₂-based wires fabricated in some embodiments as described above, or may be a combination of monofilament MgB₂-based wires fabricated in some embodiments as described above, and elemental or composite wires that may include any of a wide variety of metals, including silver, gold, platinum, palladium, rhodium, iridium, ruthenium, osmium, copper, aluminum, iron, nickel, chromium, titanium, molybdenum, tungsten, tantalum, niobium, magnesium, or vanadium, alloys and intermetallic mixtures thereof. In some embodiments, the metal sheathing strip can comprise metals, including silver, gold, platinum, palladium, rhodium, iridium, ruthenium, osmium, copper, aluminum, iron, nickel, chromium, titanium, molybdenum, tungsten, tantalum, niobium, magnesium, or vanadium, stainless steel, alloys and intermetallic mixtures thereof. Selection of the metal of the strip will be determined by one skilled in the art with reference to reactivity properties of metal with superconducting materials. In a preferred embodiment, the metal sheathing strip will comprise niobium, titanium, iron or stainless steel metal. The thickness of the metal sheathing strip is not critical and can be adjusted to the minimum thickness necessary for processing to small diameter wire.

It may be desirable, due to subsequent processing conditions in forming the metal tube, e.g., heat treatment or drawing, in some embodiments, that the finished metal tube consists of multiple tubes so that there are inner tube(s) and outer tube(s). The metal of the inner tubes may be selected from a group of metals including nickel, titanium, molybdenum, tantalum, iron, niobium, tungsten, magnesium, vanadium, their alloys and intermetallic mixtures, and the like. In some embodiments, preferred materials for an inner tube include iron, titanium, niobium and tantalum. Whether or not an inner tube is used, an outer tube can also be utilized as a stabilizer to aid in distribution of currents during a quench and/or to provide mechanical strength to the final wire. The outer tube may be formed from a metal selected from the group including gold, silver, platinum, palladium, rhodium, copper and aluminum, carbon steel, stainless steel, copper-nickel, Monel, or nickel alloy, with Monel and stainless steel being among preferred embodiments.

The metal sheathing strip and group of wires may be fed from feed rolls, passing between shaping dies or forming rolls where the metal sheathing strip is bent to a U-shaped configuration.

In some embodiments, the filled U-shaped configuration may then proceed through various closing dies to form an O-shaped closed tube. The closed tube is formed such that ends of the U-shaped configuration are approximated or overlapped and are then mechanically or metallurgically bonded as the filled tube continues through any of a number of means for reducing the dimensional area of the tube. Means for area reduction are known to those skilled in the art and include wire drawing or forging by means of dies, roller dies, swagers or extruders, and the like, whichever means are selected for area reduction. In some embodiments, the cross section of the metal tube will generally be an annulus having a reduced dimensional area in an amount from about 15% to about 99.99%, depending on the final use of the wire and the current-carrying requirements. In some embodiments, it is preferable that the reduction in dimensional area be from about 90% to about 99.99%. Various interventions may take place at this point, such as, by way of example only and not limitation, other processes like rectangular shaping, twisting, and integration with Cu and/or insulating. Following area reduction, the metal sheathing strip will proceed to heat treatment to sinter or chemically react the contents of the tube. Heat treatment of the tube can occur continuously, such as with an inline furnace or resistive heating apparatus, or in a batch type oven. The heat treatment can involve a simple heating of the metal tube to a specific temperature for a specified time, or may be such that the tube is subjected to cycle of heating and cooling to various temperatures and for varying times. In other embodiments, heat treatment may be carried out by electrically resistive means with a current source applying current through the wire insulated electrically and thermally. In some embodiments, heat treatment may be carried out at a temperature of from about 525° C. to about 1000° C., for a time of about one minute to about 6 hours. The metal tube can then be wound into a coil or similar article. It is to be understood, however, that heat or other treatments may be performed either before or after winding of the tube.

In summary, what is claimed then is a method for continuously forming superconducting wire, and products made by such method and methods. While the steps are presented in a certain order, it is emphasized that one skilled in the art may change the order of the steps, as well as may add additional steps to the method. This method, in one embodiment seen well in FIG. 1, may begin with a first step of providing at least one continuous metal sheathing strip (100) and at least one metal form (200). Next, one may continuously form the at least one continuous metal sheathing strip (100) to form a metal sheathing strip partially open configuration (110) partially enclosing a precursor volume by applying a metal sheathing strip conforming means (300) to form a metal sheathing strip partially open configuration (110) having a metal sheathing strip first edge (122) and a metal sheathing strip second edge (124). Again with reference to FIG. 1, as a third step, one may continuously fill the open precursor volume with at least one magnesium diboride precursor (400) comprising boron, and the metal form (200), as seen cross-sectionally in FIG. 2.

Subsequently, one may close the metal sheathing strip partially open configuration (110) by applying a metal sheathing strip conforming means (300) to form a metal sheathing strip closed configuration (130) enclosing the precursor volume, as seen well in FIG. 3. As a fourth step, not shown, one may deform the metal sheathing strip closed configuration (130) to reduce the diameter and elongate the length of the metal sheathing strip closed configuration (130) to a predetermined final configuration having a predetermined diameter and length. To complete the formation of the superconducting wire, one may heat the final configuration, also not shown, at a predetermined temperature and predetermined time to catalyze at least a partial conversion of the magnesium diboride precursor (400) comprising boron, and metal form (200), to magnesium diboride.

There may be many additional aspects to the steps enumerated above, all of which are given by way of example, and not limitation, only. The step of providing at least one continuous metal sheathing strip (100) and at least one metal form (200) may include dispensing the at least one continuous metal sheathing strip (100) from a metal sheathing strip dispenser (105) and dispensing the metal form (200) from a metal form dispenser (205), as seen in FIGS. 1, 4, and 7.

Similarly, and also seen in FIGS. 1, 4, and 7, the step of continuously forming the at least one continuous metal sheathing strip (100) by applying a metal sheathing strip conforming means (300) to form a metal sheathing strip partially open configuration (110) may include passing the metal sheathing strip fully open configuration (110) under at least one shaping die (310).

Also, the step of closing the metal sheathing strip partially open configuration (110) by applying a metal sheathing strip conforming means (300) may further include passing the metal sheathing strip partially open configuration (110) under at least one closing die (320).

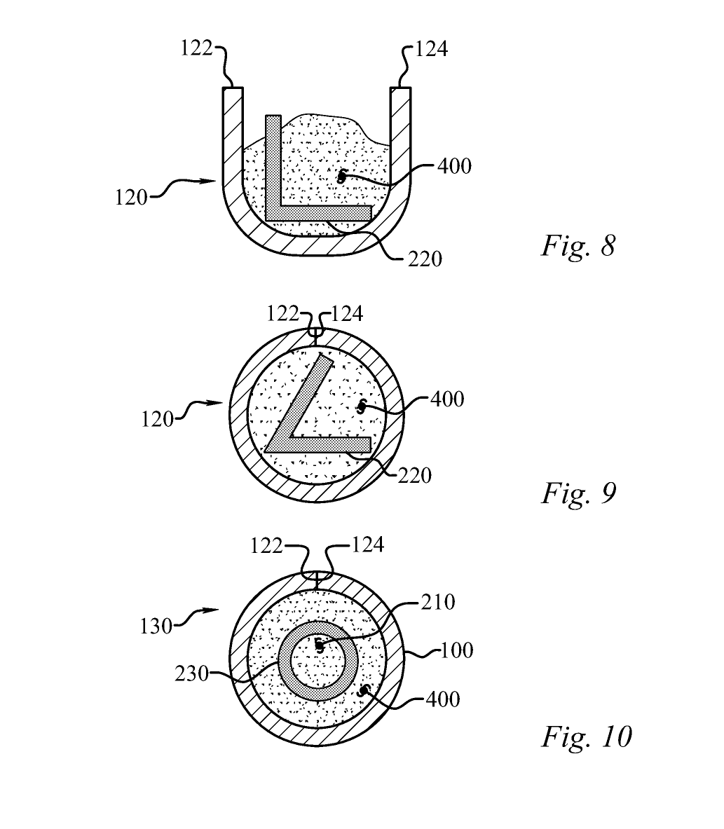

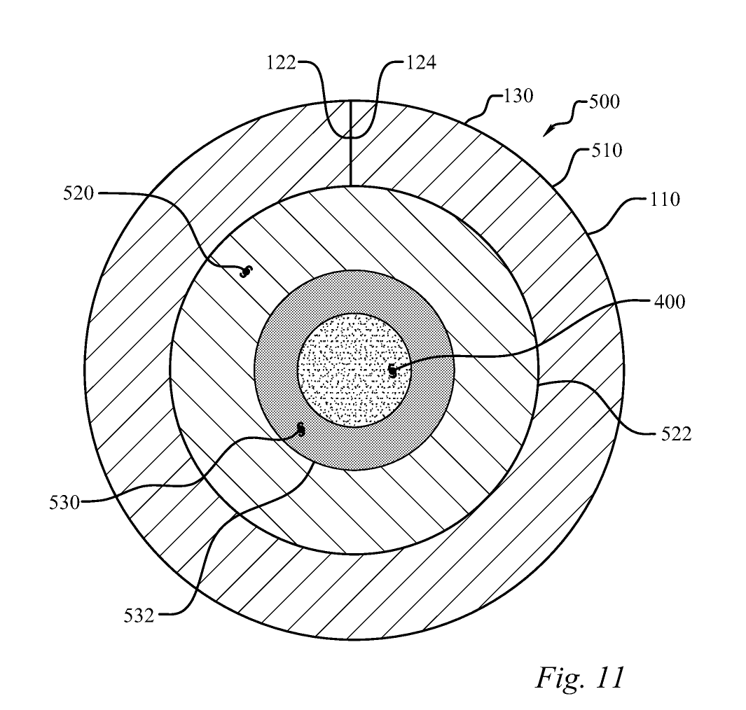

Again with reference to FIGS. 1, 4 and 7, a wide range of material forms may be employed, as would be known by one skilled in the art. The step of continuously filling the open precursor volume with at least one magnesium diboride precursor (400) comprising boron and a metal form (200) may include dispensing powdered magnesium diboride precursor (400) comprising boron from a magnesium diboride precursor powder distributor (410). The at least one continuous metal sheathing strip (100) may include a plurality of continuous strips (100), not shown. The at least one metal form (200) may be a solid metal form (200), and this solid metal form (200) may be at least one metal form selected from the group of metal forms consisting of wire metal forms (210), seen in FIG. 8, strip metal forms (220), seen in FIG. 9, and partially hollow metal forms (230), as seen in FIG. 10. Partially hollow metal forms (230), such as those seen in FIG. 10 may need to be at least partially filled with magnesium diboride precursors (400) comprising boron during the process.

The at least one continuous metal sheathing strip (100) comprises a metal selected from the group of metals consisting of Nb, Ta, Ti, Ni, Fe, Cr, Al, Cu and alloys thereof, and such allows may include stainless steel, 80Ni-20Cr, and mixtures thereof. In the same manner, the at least one metal form (200) may include magnesium and magnesium alloys.

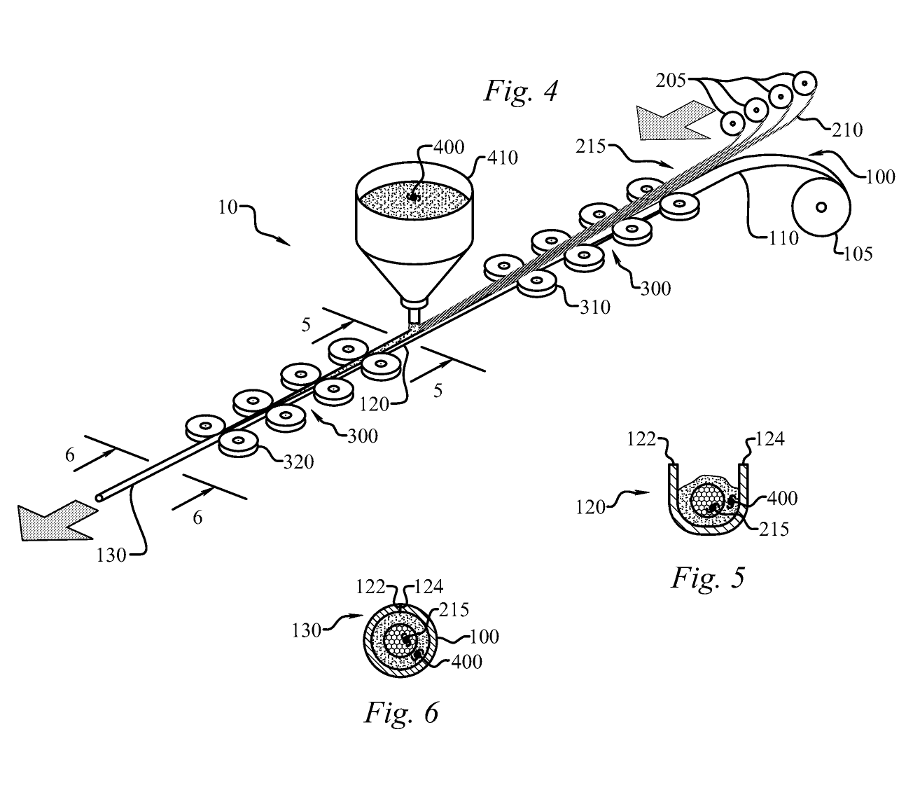

Again referring to material forms, the wire metal form (210), seen well in FIGS. 1, 2, and 3, may be formed as at least one monofilament wire metal form (210), which may have a diameter of less than 200 microns, and in fact, may have a diameter of less than 100 microns and may include a monofilament MgB₂ based wire. In other embodiments, the at least one monofilament wire form (210) further comprises a plurality of monofilament wires, seen well in FIGS. 4, 5, and 6, while the at least one metal form (200) may include a powdered metal form (200). The magnesium diboride precursors (400) comprising boron may include solid or powdered magnesium diboride precursors (400).

Various additives may appear in certain embodiments. The magnesium diboride precursor (400) comprising boron may include an additive such as C, Ti, one or more hydrocarbons; one or more organic compounds; one or more plastics, one or more oxides, one or more fluorocarbons, Si₃N₄, CaB₆, SiCl₄, TiCl₄, B₄C, ZrB₂, ZrH₂, SiC, TiC, Ag, Fe, Ta, and Mo.

Among such additives, the one or more hydrocarbons may include toluene or hexane. Similarly, the one or more alcohols may include isopropyl alcohol, methyl alcohol, or ethyl alcohol. The one or more organic compounds may include malic acid, pyrene, or butylated hydroxytoluene (BHT). The plastics may include polypropylene carbonate (PPC).

The magnesium or boron supplying precursors may be presented in different forms, including powder having particle sizes of less than 40 microns, and even as nano-powders, where particle sizes may be at least 10 nanometers and not greater than 100 nanometers.

Various ratios of magnesium diboride precursor (400) comprising boron to metal forms (200) are possible, and one skilled in the art will readily determine the most advantageous ratios. In one embodiment, by way of illustration only and not limitation, the magnesium diboride precursor (400) comprising boron and a metal form (200) may exist in an atomic ratio comprising between approximately 0.7:2 to 1.3:2 metal form (200) to magnesium diboride precursor (400) comprising boron.

Likewise, one skilled in the art will ascertain the correct temperature and times for heat treatment of the metal sheathing strip closed configuration (130). In some embodiments, the predetermined temperature is from 600 to 900 degrees centigrade, while in others, the predetermined temperature is between 600 and 750 degrees centigrade. In the same vein, in some embodiments, the predetermined time of heat treatment is between 1 second and 6 hours, while in other embodiments, the predetermined time for heat treatment is between 0.5 and 4 hours.

Various spatial relationships may exist between the magnesium diboride precursor (400) comprising boron, and the metal form (200), within the final superconducting wire formed by the method. In some embodiments, they exist as a central metal form (200) surrounded by a layer of magnesium diboride precursor (400) comprising boron. In some embodiments, the final wire is formed as a central metal form (200) surrounded by a layer of magnesium diboride precursor (400) comprising boron being approximately 500 microns thick. In still other embodiments, the final wire may have a central metal form (200) surrounded by a layer of magnesium diboride precursor (400) comprising boron being approximately 100 microns thick, or even embodiments wherein the layer of magnesium diboride precursor (400) comprising boron is approximately between 1 and 100 microns thick. In one preferred embodiment, by way of example only and not limitation, a layer of magnesium diboride precursor (400) comprising boron may be between approximately 25 and 50 microns thick. In some embodiments, the final wire manufactured will be between 0.1 mm and 2.0 mm thick.

Various superconducting wire products may be made according to the method, as seen in FIGS. 11 through 14, and the following examples are not exhaustive, but only representative. One superconducting wire (500), seen in FIG. 11, may be structured as an outer sheath (510), enclosing at least one intermediate material (520), and a metal form (200). The intermediate material (520) may exist as an intermediate material tube (522), and in yet other embodiments, a partially hollow metal form (530).

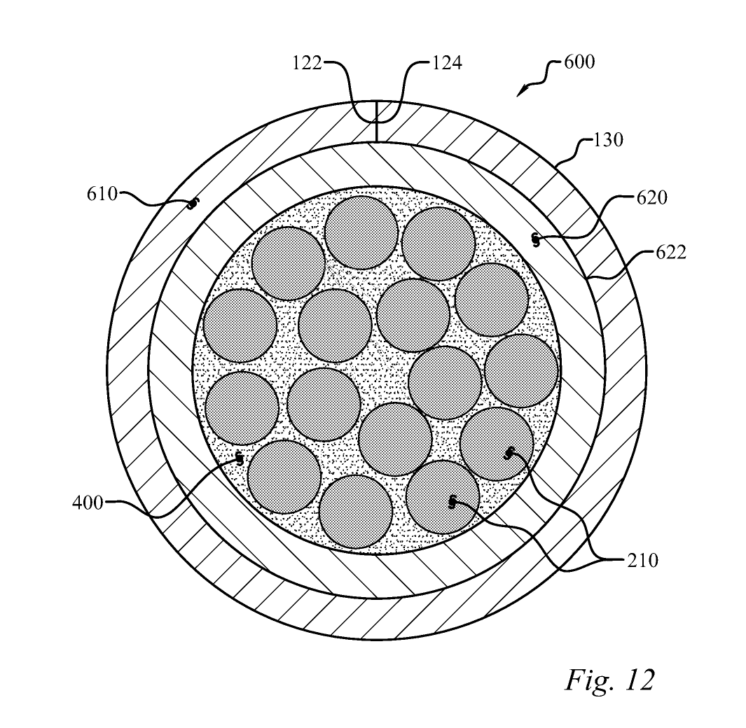

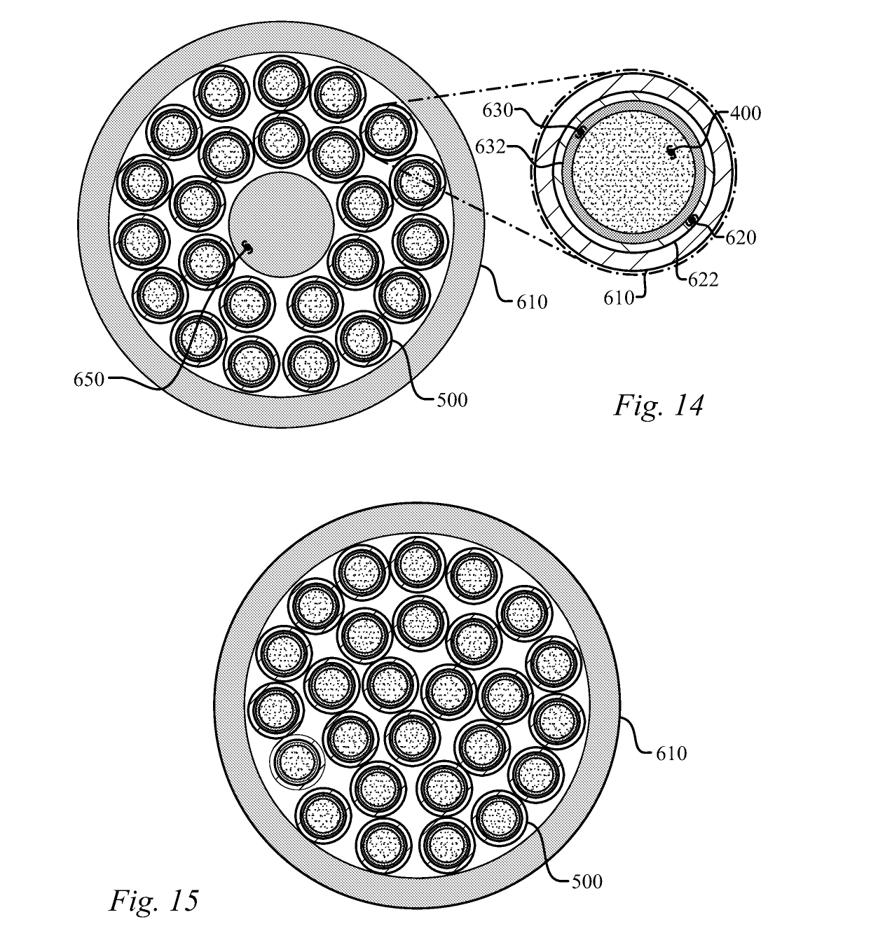

Other superconducting wire products, as seen in FIG. 12, may include superconducting wire (600) having an outer sheath (610), a plurality of metal forms (210), an intermediate material (620), and a metal form (630). The intermediate material (620) may be formed as an intermediate material tube (622). The superconducting wire may include embodiments wherein the metal form (630) may be a partially hollow metal form (632), as seen in FIGS. 14 and 15, and also as seen in FIGS. 14 and 15, superconducting “cable” may be formed by enclosing a plurality of superconducting wires (500) within yet another outer sheath (610). In embodiments such as seen here, the superconducting wire may be configured with, as seen in FIG. 14, or without, as seen in FIG. 15, a core (650). In some embodiments, the core (650) may include any of a wide range of conductive materials, including by way of example and not limitation only, Cu, Ag, Au, Pt, Ti, and Ni. Numerous alterations, modifications, and variations of the preferred embodiments disclosed herein will be apparent to those skilled in the art and they are all anticipated and contemplated to be within the spirit and scope of the instant invention. Further, although specific embodiments have been described in detail, those with skill in the art will understand that the preceding embodiments and variations can be modified to incorporate various types of substitute and or additional or alternative materials, relative arrangement of elements, and dimensional configurations. Accordingly, even though only few variations of the present invention are described herein, it is to be understood that the practice of such additional modifications and variations and the equivalents thereof, are within the spirit and scope of the invention as defined in the following claims.

We claim:

1. A method for continuously forming superconducting wire, comprising the steps of;
a. providing at least one continuous metal sheathing strip (100) and at least one metal form (200);
b. continuously forming the at least one continuous metal sheathing strip (100) by applying a metal sheathing strip conforming means (300) to form a metal sheathing strip partially open configuration (110) having a metal sheathing strip first edge (122) and a metal sheathing strip second edge (124) to form a metal sheathing strip partially open configuration (110) partially enclosing a precursor volume;
c. continuously filling the open precursor volume with at least one magnesium diboride precursor (400) comprising boron, and the metal form (200);
d. closing the metal sheathing strip partially open configuration (110) by applying a metal sheathing strip conforming means (300) to form a metal sheathing strip closed configuration (130) enclosing the precursor volume;
e. deforming the metal sheathing strip closed configuration (130) to reduce the diameter and elongate the length of the metal sheathing strip closed configuration (130) to a predetermined final configuration having a predetermined diameter and length;
f. heating the final configuration at a predetermined temperature and predetermined time to catalyze at least a partial conversion of the at least one magnesium diboride precursor (400) comprising boron and metal form (200) to magnesium diboride.

2. The method according to claim 1, wherein the step of providing at least one continuous metal sheathing strip (100) and at least one metal form (200) further comprises dispensing the at least one continuous metal sheathing strip (100) from a metal sheathing strip dispenser (105) and dispensing the metal form (200) from a metal form dispenser (205).

3. The method according to claim 1, wherein the step of continuously forming the at least one continuous metal sheathing strip (100) by applying a metal sheathing strip conforming means (300) to form a metal sheathing strip partially open configuration (110) further comprises passing the metal sheathing strip fully open configuration (110) under at least one shaping die (310).

4. The method according to claim 1, wherein the step of closing the metal sheathing strip partially open configuration (110) by applying a metal sheathing strip conforming means (300) further comprises passing the metal sheathing strip partially open configuration (110) under at least one closing die.

5. The claim according to claim 1, wherein the step of continuously filling the open precursor volume with at least one magnesium diboride precursor (400) comprising boron, and the metal form (200), further comprises dispensing at least one powdered magnesium diboride precursor (400) comprising boron from a magnesium diboride precursor powder distributor (410).

6. The method according to claim 1, wherein the at least one continuous metal sheathing strip (100) further comprises a plurality of continuous strips (100).

7. The method according to claim 1, wherein the at least one continuous metal sheathing strip (100) comprises a metal selected from the group of metals consisting of Nb, Ta, Ti, Ni, Fe, Cr, Al, Cu and alloys thereof.

8. The method according to claim 7, wherein the alloy comprises an alloy selected from the group of alloys consisting of stainless steel, 80Ni-20Cr, and mixtures thereof.

9. The method according to claim 1, wherein the at least one metal form (200) further comprises a metal selected from the group of metals consisting of magnesium and magnesium alloys.

10. The method according to claim 1, wherein the at least one metal form (200) further comprises a powdered metal form (200).

11. The method according to claim 1, wherein the at least one magnesium diboride precursor (400) comprising boron further comprises an additive selected from the group of additives consisting of C, Ti, one or more hydrocarbons, one or more organic compounds, one or more plastics, one or more oxides, one or more fluorocarbons, Si₃N₄, CaB₆, SiCl₄, TiCl₄, B₄C, ZrB₂, ZrH₂, SiC, TiC, Ag, Fe, Ta, and Mo.

12. The method according to claim 11, wherein the one or more hydrocarbons is selected from the group of hydrocarbons consisting of toluene and hexane.

13. The method according to claim 11, wherein the one or more alcohols is selected from the group of alcohols consisting of isopropyl alcohol, methyl alcohol, and ethyl alcohol.

14. The method according to claim 11, wherein the one or more organic compounds is selected from the group of organic compounds consisting of malic acid, pyrene and BHT.

15. The method according to claim 11, wherein the one or more plastics further comprises polypropylene carbonate (PPC).

16. The method according to claim 1, wherein the at least one magnesium diboride precursor (400) comprising boron further comprises a powder having a particle size of less than 40 microns.

17. The method according to claim 1, wherein the at least one magnesium diboride precursor (400) comprising boron further comprises a powder having a particle size of at least 10 nanometers and not greater than 100 nanometers.

18. The method according to claim 1, wherein the step of continuously filling the precursor volume with at least one magnesium diboride precursor (400) comprising boron and a metal form (200) further comprises filling the precursor volume with at least one magnesium diboride precursor (400) comprising boron and a metal form (200) in an atomic ratio comprising between approximately 0.7:2 to 1.3:2 metal form (200) to magnesium diboride precursor (400) comprising boron.

19. The method according to claim 1, wherein a superconducting wire produced according to the method comprises a central metal form (200) surrounded by a layer of magnesium diboride precursor (400) comprising boron.

20. A superconducting wire (500) comprising;
an outer sheath (510),
an intermediate material (520), and
a metal form (530).

21. The superconducting wire of claim 20 wherein the intermediate material (520) further comprises an intermediate material tube (522).

22. A superconducting wire (600) comprising;
an outer sheath (610),
a plurality of superconducting wires (500),
an intermediate material (620), and
a metal form (630)

23. The superconducting wire of claim 22 wherein the intermediate material (620) further comprises an intermediate material tube (622).

24. The superconducting wire of claim 22 wherein the metal form (630) further comprises a partially hollow metal form (632).

25. The superconducting wire of claim 22 further comprising a core (650).

26. The superconducting wire of claim 25 wherein the core further comprises at least one conductive material selected from the group of conductive materials consisting of Cu, Ag, Au, Pt, Ti, and Ni.
